(19) United States
(12) Patent Application Publication
(10) Pub. No.: US 2024/0288277 A1
(43) Pub. Date: Aug. 29, 2024

(54) PARKING LOT INFORMATION ANALYSIS DEVICE AND PARKING LOT INFORMATION ANALYSIS METHOD

(71) Applicant: HONDA MOTOR CO., LTD., Tokyo (JP)

(72) Inventor: Yoshiaki SUGIMOTO, Tokyo (JP)

(21) Appl. No.: 18/572,187

(22) PCT Filed: Jun. 7, 2022
(86) PCT No.: PCT/JP2022/022902

§ 371 Date: Dec. 20, 2023

(30) Foreign Application Priority Data
Jul. 13, 2021 (JP) 2021-115468

(51) Int. Cl. G01C 21/36; G01C 21/00

(52) U.S. Cl. CPC G01C 21/3685; G01C 21/3682; G01C 21/3841; G01C 21/3867

(57) ABSTRACT

The parking lot information analysis device comprises: a storage unit storing center position information pertaining to a facility regarding a plurality of facilities; a reception unit receiving consecutive position information, together with time information, from a plurality of vehicles; a parking position information recording unit for assessing that a vehicle has parked when there is no change in the position information for a prescribed time, and storing the assessment in the storage unit; and a parking lot assessment unit plotting a plurality of items of parking position information to a plurality of grids in a prescribed range from the center position information pertaining to one facility stored in the storage unit, and assessing, when the number of items of parking position information plotted within a grid is greater than or equal to the prescribed value, that the grid represents parking lot shape information pertaining to the facility.

### TECHNICAL FIELD

The present invention relates to a parking lot information analysis device and a parking lot information analysis method for determining a shape of a parking lot of a facility based on positional information from a plurality of vehicles.

### BACKGROUND ART

A server receives GPS positional information from a plurality of vehicles and uses the received GPS positional information for data analysis about facilities based on the accumulated positional information. For example, Patent Document 1 discloses, as a technology for recording a parking position, a technology for acquiring GPS positional information by starting an engine, generating parking information including a start time of an engine at the present time, a stop time of the engine at the previous time, and a parking position, and transmitting the information to a parking information collection server, in which the parking information collection server collects the total parking hours and the total number of parking times for each of the partitions obtained by dividing a map by a plurality of small partitions based on the parking information collected from a plurality of vehicles, thereby generating parking ranking information indicating a ranking of the partitions. Conventionally, for parking in a facility, the parking in the facility is determined by determining whether or not positional information of a vehicle remains within a predetermined radius from the latitude and latitude serving as a center point of the facility for a predetermined period of time. However, it is necessary to record the partition information of the parking lot on the map to determine whether or not the vehicle is parked for the purpose of visiting the facility. As a technique for this purpose, for example, Patent Document 2 (paragraph 0029, FIG. 4, etc.) discloses a technique for defining a facility in a polygon to determine visits thereto within an area defined by connecting vertexes of the polygon.

### CITATION LIST

### Patent Document

Patent Document 1: Japanese Unexamined Patent Application, Publication No. 2008-282234
Patent Document 2: Japanese Patent No. 3539629

### DISCLOSURE OF THE INVENTION

### Problems to be Solved by the Invention

The technique disclosed in Patent Document 2 needs to create map information including a section of a parking lot of a facility, which increases the cost burden on map providers and makes it difficult to realize the technique.

The present invention has been made in view of such a disadvantage, and an object of the present invention is to provide a parking lot information analysis device and a parking lot information analysis method for determining a shape of a parking lot of a facility by calculating the estimated number of parked vehicles in a plurality of grids within a predetermined range from a center point of the facility, thereby making it possible to determine whether or not the grid corresponds to a parking lot of the facility without manually creating the shape of the parking lot of the facility.

### Means for Solving the Problems

(1) A parking lot information analysis device (for example, a parking lot information analysis device 30 described later) according to an embodiment of the present invention includes: a map information storage unit (for example, a map information storage unit 321 described later) that stores map information including center position information of a plurality of facilities; a receiving unit (for example, a receiving unit 311) that receives consecutive positional information, together with time information, from each of a plurality of vehicles; a parking lot position information recording unit (for example, a parking lot position information recording unit 312 described later) that determines that, when there is no change in the positional information for a predetermined period of time or more, a vehicle of the positional information has been parked, and stores the positional information as parking position information of the vehicle; and a parking lot determination unit (for example, a parking lot determination unit 313 described later) that plots a plurality of pieces of the parking position information into a plurality of grids within a predetermined range from center position information of one facility stored in the map information storage unit, and determines that, when a number of pieces of parking position information plotted in the grid is equal to or greater than a predetermined value, the grid corresponds to shape information of a parking lot of the facility.

According to the above (1), by calculating the estimated number of parked vehicles in each grid in a plurality of grids in a predetermined range from the center point of the facility, it is possible to create polygons of parking areas of the facility by determining whether or not each grid is a parking area of the facility without manually creating the shape of the parking area of the facility.

(2) In the parking lot information analysis device (for example, the parking lot information analysis device 30 described later) according to (1), the parking lot determination unit (for example, the parking lot determination unit 313 described later) may determine an outline of a group of grids determined as the parking lot as the shape information of the parking lot of the facility as boundary information of the parking lot.

According to the above (2), it is possible to create boundary line information of the parking lot of the facility without manual intervention.

(3) In the parking lot information analysis device (for example, the parking lot information analysis device 30 described later) according to (1) or (2), the parking lot determination unit (for example, the parking lot determination unit 313 described later) may regard a grid having a number of pieces of parking position information of the grid determined to be the parking lot changes from a decrease to an increase as a parking lot of one other facility different from the facility, and determine the shape of the parking lot of the facility as boundary information of parking lots of the facility and the other facility.

According to the above (3), even when two facilities are located nearby (e.g., adjacent to each other along a street road), it is still possible to determine the boundary between the parking lots of the two facilities without manually creating the shapes of the respective parking lots.

(4) The parking lot information analysis device (for example, the parking lot information analysis device 30 described later) according to (1) to (3) may further include a parking lot recording unit (for example, the parking lot recording unit 314 described later) that stores the shape information of the parking lot of the facility determined by the parking lot determination unit (for example, the parking lot determination unit 313 described later) in the map information storage unit.

According to the above (4), it is possible to create a map including the shape of the parking lot without manually creating the shape of the parking lot of the facility.

(5) A parking lot information analysis method according to an embodiment of the present invention is a parking lot information analysis method executed by a computer, the method including the steps of: storing map information including center position information of a plurality of facilities; receiving consecutive positional information, together with time information, from each of a plurality of vehicles; determining that, when there is no change in the positional information for a predetermined period of time or more, a vehicle of the positional information has been parked, and storing the positional information as parking position information of the vehicle; and plotting a plurality of pieces of the parking position information into a plurality of grids within a predetermined range from center position information of one facility stored in the map information storage unit, and determining that, when a number of pieces of parking position information plotted in the grid is equal to or greater than a predetermined value, the grid corresponds to shape information of a parking lot of the facility.

According to the method of (5), the same advantageous effect as that of the parking lot information analysis device of the above (1) can be obtained.

### Effects of the Invention

According to an embodiment of the present invention, it is possible to provide a parking lot information analysis device and a parking lot information analysis method for determining a shape of a parking lot of a facility by calculating the estimated number of parked vehicle in a plurality of grids within a predetermined range from a center point of the facility, thereby making it possible to determine whether or not the grid corresponds to a parking lot of the facility without manually creating the shape of the parking lot of the facility.

### BRIEF DESCRIPTION OF THE DRAWINGS

FIG. 1 is a block diagram showing a basic configuration of an entire parking lot information analysis system according to an embodiment of the present invention;

FIG. 2 is a functional block diagram showing a functional configuration of an onboard navigation device according to an embodiment of the present invention;

FIG. 3 is a functional block diagram showing a functional configuration of a mobile terminal according to an embodiment of the present invention;

FIG. 4 is a functional block diagram showing a functional configuration of a parking lot information analysis device according to an embodiment of the present invention;

FIG. 5 is a table showing an example of a positional information database according to an embodiment of the present invention;

FIG. 6 is a schematic diagram showing a process for determining a shape of a parking lot of one facility according to an embodiment of the present invention;

FIG. 7A is a diagram showing an outline of determining a boundary between parking lots of two facilities according to an embodiment of the present invention;

FIG. 7B is a diagram showing an outline of a distribution of the number of pieces of parking position information in a plurality of grids according to an embodiment of the present invention;

FIG. 7C is a diagram showing an outline of determining a boundary between parking lots of two facilities according to an embodiment of the present invention;

FIG. 8 is a flowchart showing an operation of determining a shape of a parking lot of one facility according to an embodiment of the present invention; and

FIG. 9 is a flowchart showing an operation of determining a boundary between two adjacent (or neighboring) facility parking lots in an embodiment of the present invention.

### PREFERRED MODE FOR CARRYING OUT THE INVENTION

Hereinafter, a preferred embodiment of the parking lot information analysis system of the present invention will be described in detail with reference to the drawings.

### <Overall Configuration of Parking Lot Information Analysis System 1>

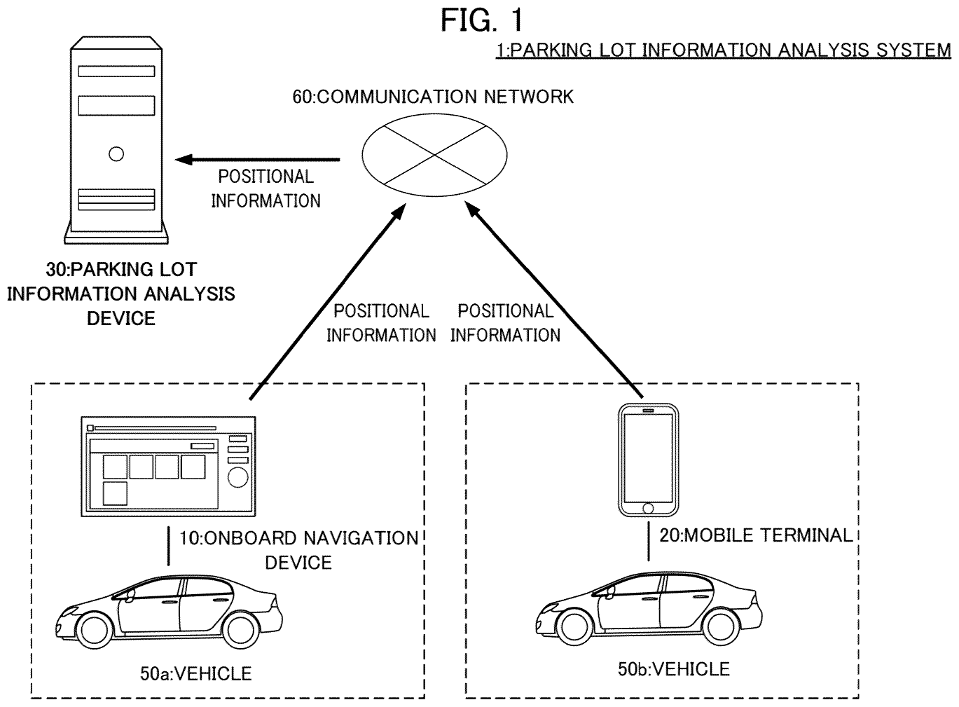

A parking lot information analysis system 1 according to a preferred embodiment of the present invention will be described. FIG. 1 shows the overall configuration of a parking lot information analysis system 1.

As shown in FIG. 1, the parking lot information analysis system 1 includes an onboard navigation device 10, a mobile terminal 20, and a parking lot information analysis device 30. These devices and terminals are communicably connected to each other via a communication network 60. It is to be noted that, although information transmitted and received by each device and each terminal is also illustrated in the figure, these information are merely examples. In the present embodiment, information other than the illustrated information may be transmitted and received.

The onboard navigation device 10 is a device for performing navigation (route guidance) to a user who rides on a vehicle 50a. The onboard navigation device 10 also has a function of positioning positional information of the onboard navigation device 10 (i.e., positional information of the vehicle 50a). The onboard navigation device 10 performs route guidance from a current position to a destination based on a request of a user who rides on the vehicle 50 and positional information that has been measured.

Further, the onboard navigation device 10 appropriately transmits the measured positional information to the parking lot information analysis device 30 together with the mobile body ID and the date and time information which are identification information for identifying the onboard navigation device 10. Here, since the onboard navigation device 10 and the vehicle 50a are used as a one-to-one pair, the positional information to be transmitted can be substantially regarded as the positional information of the vehicle 50a. Such an onboard navigation device 10 can be realized by a portable car navigation device installed in the vehicle 50a as a moving body, or PND (Portable Navigation Device) simply installed in the vehicle 50a as a moving body.

The mobile terminal 20 is a portable terminal used by a user who rides on the vehicle 50b. Similarly to the onboard navigation device 10 described above, the mobile terminal 20 has a function of performing navigation (route guidance) and a function of positioning positional information of the mobile terminal 20 (that is, positional information of the vehicle 50b).

Then, similarly to the onboard navigation device 10 described above, the mobile terminal 20 appropriately transmits the positioned positional information to the parking lot information analysis device 30 together with the mobile body ID and the date and time information which are identification information for identifying the mobile terminal 20. Here, since the mobile terminal 20 and the vehicle 50b are used as a one-to-one pair, the positional information to be transmitted can be substantially regarded as the positional information of the vehicle 50b. Such a mobile terminal 20 can be realized by a smartphone, a mobile phone, a tablet terminal, a notebook computer, and other portable electronic devices.

It should be noted that, in the drawings, each of the set of the onboard navigation device 10 and the vehicle 50a and the set of the mobile terminal 20 and the vehicle 50b is shown, but the number of these sets is not particularly limited, and any number of these sets may be included in the present embodiment. Similarly, the number of the parking lot information analysis devices 30 is not particularly limited, and any number of the parking lot information analysis devices 30 may be included in the present embodiment.

Further, in the following description, when the vehicle 50a on which the onboard navigation device 10 is mounted and the vehicle 50b on which the user using the mobile terminal 20 rides are referred to without being distinguished from each other, the letter at the tail is omitted and the vehicle 50 is simply referred to as a “vehicle 50”. Further, the vehicle 50 and the onboard navigation device 10 and the mobile terminal 20 used by the vehicle 50 move along with the movement of the vehicle 50. Therefore, in the following description, the vehicle 50, the onboard navigation device 10, and the mobile terminal 20 are appropriately referred to as a “mobile body”.

The parking lot information analysis device 30 is a device capable of more accurately analyzing the shape of a parking lot of a facility where each vehicle 50 is parked based on consecutive positional information, etc., received from a plurality of vehicles 50. With such a configuration, the parking lot information analysis device 30 can create a map having, for example, the shape of a parking lot without manually creating the shape of the parking lot of the facility. The vehicle 50 is a mobile body on which a user of the onboard navigation device 10 or the mobile terminal 20 rides. The vehicle 50 is implemented by, for example, a four-wheeled vehicle, a motorcycle, or the like.

The communication network 60 is implemented by a network such as the Internet or a mobile phone network, or a network obtained by combining these networks. Further, a LAN (Local Area Network) may be included in a part of the network. Before describing the parking lot information analysis device 30, the onboard navigation device 10 and the mobile terminal 20 will be briefly described.

### <Onboard Navigation Device 10>

The onboard navigation device 10 is supplied with power from the vehicle 50a, and automatically starts when an ignition switch of the vehicle 50a is turned on (an engine is started) by a user who rides on the vehicle 50a. The onboard navigation device 10 operates until the ignition switch of the vehicle 50a is turned off (the engine is stopped) by the user who rides on the vehicle 50a.

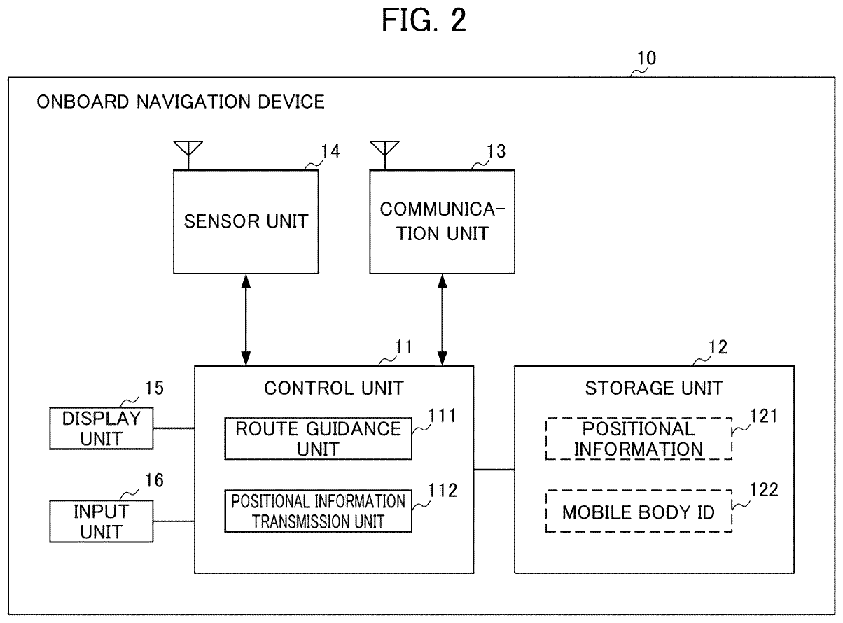

As shown in FIG. 2, the onboard navigation device 10 includes a control unit 11, a storage unit 12, a communication unit 13, a sensor unit 14, a display unit 15, and an input unit 16.

The control unit 11 includes an arithmetic processing unit such as a microprocessor, and controls each unit constituting the onboard navigation device 10. The details of the control unit 11 will be described later.

The storage unit 12 includes semiconductor memory or the like, and stores various kinds of information such as control programs called firmware and an operating system, programs for performing route guidance processing, programs for performing positional information transmission processing to the parking lot information analysis device 30, and map information including facility information and facility ID for route guidance.

In the figure, as the information stored in the storage unit 12, positional information 121 and mobile body ID 122, which are information specific to the transmission processing of the positional information, are illustrated. The positional information 121 is positional information of the onboard navigation device 10 (i.e., positional information of the vehicle 50a) positioned or located by the sensor unit 14 described later. The positional information 121 may include not only the information indicating the positioned or located position, but also the time at which the positioning is performed.

The mobile body ID 122 is information for identifying the onboard navigation device 10 and the vehicle 50a in which the onboard navigation device 10 is installed. As the mobile body ID 122, for example, a manufacturing number uniquely assigned to the onboard navigation device 10 can be used. In addition, since the communication unit 13 is connected to the communication network 60 which is a network such as a mobile phone network, the telephone number assigned to SIM (Subscriber Identity Module) inserted in the communication unit 13 can be used as the mobile body ID 122. In addition, a VIN (vehicle identification number) or a number plate number uniquely assigned to the vehicle 50a can be used as the mobile body ID 122.

The communication unit 13 includes a DSP (Digital Signal Processor) or the like, and realizes wireless communication with other devices (e.g., the parking lot information analysis device 30) via the communication network 60 according to standards such as LTE (Long Term Evolution), 4G (4th Generation) and 5G (5th Generation), and standards such as Wi-Fi (registered trademark). The communication unit 13 is used, for example, for the positional information transmission unit 112, which will be described later, to transmit the positional information 121 and the mobile body ID 122 stored in the storage unit 12 to the parking lot information analysis device 30. However, data transmitted and received between the communication unit 13 and another device is not particularly limited, and information other than the positional information 121 and the mobile body ID 122 may be transmitted and received.

The sensor unit 14 includes, for example, a GPS (Global Positioning System) sensor, a gyro sensor, an acceleration sensor, and the like. The sensor unit 14 has a function as a position detection unit for detecting positional information, receives GPS satellite signals by a GPS sensor, and positions positional information (latitude and latitude) of the onboard navigation device 10. The positioning by the sensor unit 14 is performed at a predetermined time interval (for example, three seconds) as described above. The measured positional information is stored in the storage unit 12 as the positional information 121. Since the GPS sensor can position the altitude in addition to latitude and latitude, the positional information may include the altitude in addition to latitude and latitude. The sensor unit 14 can further increase the positioning accuracy of the positional information of the onboard navigation device 10 based on the angular velocity and the acceleration measured by the gyro sensor and the acceleration sensor. The display unit 15 is configured by a display device such as a liquid crystal display or an organic electroluminescence panel. The display unit 15 displays an image in response to an instruction from the control unit 11. The input unit 16 includes a physical switch called a numeric keypad, an input device (not shown) such as a touch screen provided on the display surface of the display unit 15, and the like. In addition, although not shown, a speaker, a microphone, or the like may be provided. The speaker outputs audio to the driver, and the microphone collects audio or the like emitted by the driver. With such a configuration, information can be outputted from the speaker by sound, or various selections and instructions by the driver, which are inputted by sound via the microphone, can be inputted to the control unit 11 by the sound recognition technology.

Next, the control unit 11 will be described in detail. The control unit 11 includes a microprocessor including a CPU (Central Processing Unit), RAM (Random access memory), ROM (Read Only Memory), I/O (Input/Output), and the like. The CPU executes each program read from the ROM or the storage unit 12, reads information from the RAM, the ROM, and the storage unit 12, writes information to the RAM and the storage unit 12, and transmits and receives signals to and from the communication unit 13, the sensor unit 14, the display unit 15, and the input unit 16. Thus, the hardware and the software (program) cooperate to realize the processing in the present embodiment.

The control unit 11 includes a route guidance unit 111 and a positional information transmission unit 112 as functional blocks.

The route guidance unit 111 is a unit for performing route guidance processing to a destination such as a facility inputted or selected by a user, and is well known to those skilled in the art, so that detailed description thereof is omitted.

The positional information transmission unit 112 transmits the positional information 121 and the mobile body ID 122 stored in the storage unit 12 to the parking lot information analysis device 30 by wireless communication using the communication unit 13.

The transmission of the positional information 121 and the mobile body ID 122 to the parking lot information analysis device 30 by the positional information transmission unit 112 is periodically performed from when the ignition switch of the vehicle 50a is turned on (the engine is started) by the user riding on the vehicle 50a at the start of the drive and the vehicle navigation device 10 is automatically started, until the ignition switch of the vehicle 50a is turned off (the engine is stopped) at the end of the drive. For example, every time the sensor unit 14 performs positioning at a predetermined time interval (for example, three seconds), transmission is performed in real time. That is, transmission is performed in real time from when the drive is started until the drive is finished. Instead of transmitting to the parking lot information analysis device 30 in real time, a plurality of pieces of information may be collectively transmitted (for example, the positional information 121 updated at intervals of three seconds during three minutes and the mobile body ID 122 are collected). That is, so-called burst transmission may be performed. The length of the predetermined time interval and whether transmission is performed in real time or burst transmission is performed can be arbitrarily set according to the environment to which the present embodiment is applied. With such a configuration, by performing real-time transmission or burst transmission, the positional information transmission unit 112 transmits the positional information 121 for specifying the travel route of the vehicle 50a positioned by the sensor unit 14 and the mobile body ID 122 to the parking lot information analysis device 30.

In this case, the ignition switch is turned on (the engine is started), and the position specified by the positional information 121 measured immediately after the onboard navigation device 10 is automatically started can be transmitted to the parking lot information analysis device 30 as the first vehicle position in the drive, i.e., the departure position. Further, the position specified by the positional information 121 positioned immediately before the ignition switch is turned off (the engine is stopped) can be transmitted to the parking lot information analysis device 30 as a final vehicle position in the drive, i.e., a parking position. For example, information indicating the positional information 121 indicating the departure position and information indicating the positional information 121 indicating the parking position (for example, the value of the flag indicating these values is set to 1) are added to the positional information 121, and then transmitted to the parking lot information analysis device 30. The positional information 121 (i.e., the parking position) positioned immediately before the ignition switch is turned off (the engine is stopped) may be transmitted when the ignition switch is turned on (the engine is started) and the vehicle navigation device 10 is started again.

When burst transmission is performed, for example, when the route guidance unit 111 determines that the vehicle 50a has arrived at a destination such as a facility, the positional information transmission unit 112 can switch to perform transmission in real time. With such a configuration, it is possible to prevent a situation in which the ignition switch is turned off (the engine is stopped) after arrival at a destination such as a facility or the like and before the positional information 121 of the destination such as a facility or the like is transmitted, and the positional information 121 of the destination such as a facility or the like is not transmitted to the parking lot information analysis device 30.

Further, the positional information transmission unit 112 can transmit the velocity information of the vehicle 50a to the parking lot information analysis device 30, together with the positional information 121 and the mobile body ID 122.

### <Mobile Terminal 20>

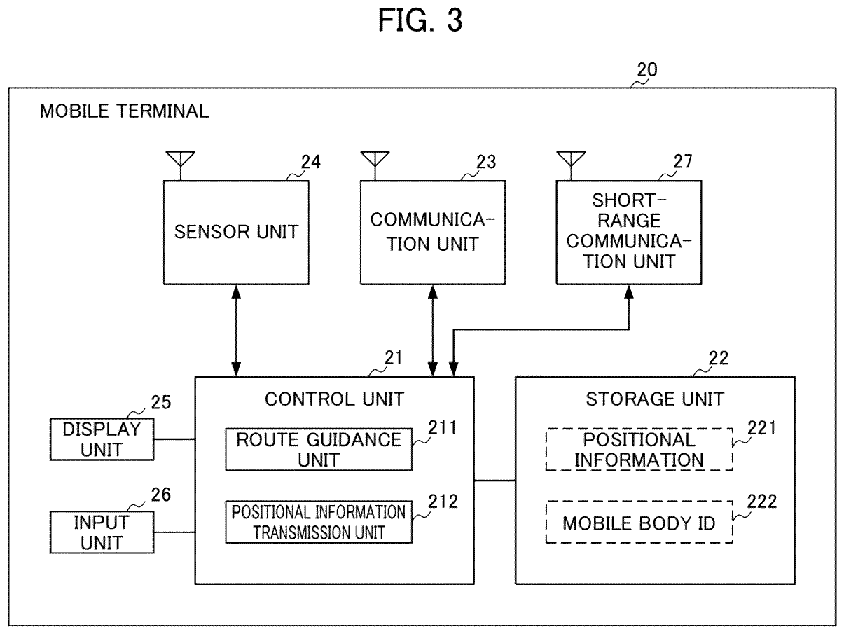

As shown in FIG. 3, the mobile terminal 20 includes a control unit 21, a storage unit 22, a communication unit 23, a sensor unit 24, a display unit 25, an input unit 26, and a short-range communication unit 27. Here, the control unit 21, the storage unit 22, the communication unit 23, the sensor unit 24, the display unit 25, and the input unit 26 have functions equivalent to those of the functional blocks having the same names included in the onboard navigation device 10. In other words, in the description of the onboard navigation device 10 described above, by replacing the language of “the onboard navigation device 10” with “the mobile terminal 20” and replacing the language of “the vehicle 50a” with “the vehicle 50b”, the functional blocks of the mobile terminal 20 will be described, and redundant descriptions thereof will be omitted.

On the other hand, since the mobile terminal 20 differs from the onboard navigation device 10 in that it includes the short-range communication unit 27, the following description will be given of the difference. The short-range communication unit 27 performs non-contact short-range communication conforming to standards such as NFC (Near Field Communication) and Bluetooth (registered trademark), or wireless short-range communication via a USB (Universal Serial Bus) cable.

On the other hand, the vehicle 50b includes a short-range communication unit for communicating with the short-range communication unit 27. For example, an ECU (Electronic Control Unit) of the vehicle 50b includes a short-range communication unit. The case where the mobile terminal 20 can communicate with the ECU by short-range communication is the case where the mobile terminal 20 exists in the vehicle 50b. In this case, the positional information positioned by the sensor unit 24 of the mobile terminal 20 corresponds to the positional information of the vehicle 50b.

Accordingly, the mobile terminal 20 activates the positional information transmission unit 212 while the mobile terminal 20 can perform short-range communication with the ECU via the short-range communication unit 27. Then, similarly to the positional information transmission unit 112 of the onboard navigation device 10, the activated positional information transmission unit 212 transmits the positional information 221 for specifying the travel route of the vehicle 50b positioned by the sensor unit 24 and the mobile body ID 222 to the parking lot information analysis device 30.

For example, when a user holds the mobile terminal 20 and rides on the vehicle 50b and turns on a start switch of the vehicle 50b such as an ignition switch, the vehicle 50b and the mobile terminal 20 are connected (paired), and then the positional information 221 measured by the mobile terminal 20 and the mobile terminal ID 222 are transmitted from the mobile terminal 20 to the parking lot information analysis device 30. Further, when the activation switch of the vehicle 50b such as the ignition switch is turned off, the pairing between the vehicle 50b and the mobile terminal 20 is released.

When the vehicle 50b has a function of positioning the positional information, instead of the positional information positioned by the sensor unit 24, the positional information measured by the vehicle 50b may be transmitted to the parking lot information analysis device 30 as the positional information 121. In this case, the sensor unit 24 may be omitted from the mobile terminal 20.

### <Parking Lot Information Analysis Device 30>

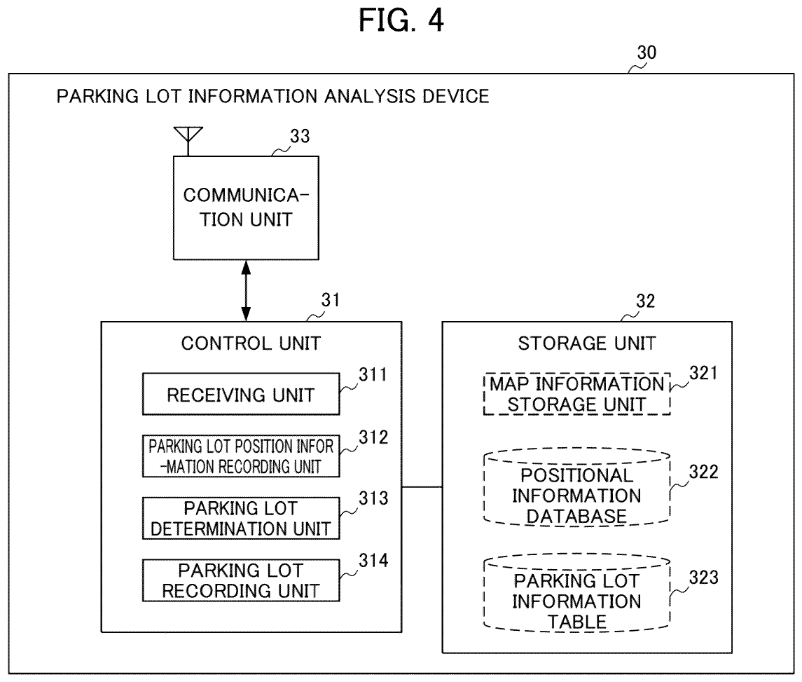

Next, functional blocks included in the parking lot information analysis device 30 will be described with reference to a block diagram of FIG. 4.

As shown in FIG. 4, the parking lot information analysis device 30 includes a control unit 31, a storage unit 32, and a communication unit 33.

The control unit 31 includes an arithmetic processing unit such as a microprocessor, and controls each unit constituting the parking lot information analysis device 30. The details of the control unit 31 will be described later.

The storage unit 32 is configured by semiconductor memory or the like, and stores various programs such as a control program called firmware or an operating system, a program for performing parking lot information analysis processing, and various other information such as map information. In the figure, as information stored in the storage unit 32, a map information storage unit 321 that stores map information, which is information related to the parking lot information analysis processing, a positional information database 322 that stores positional information of each vehicle 50, and a parking position information table 323 that stores parking position information of each vehicle 50 are illustrated.

The map information stored in the map information storage unit 321 includes, for each of a plurality of facilities, identification information (a facility ID) of the facility, a name of the facility, a facility type (and/or genre) relating to the type of the facility, a telephone number, an address, a business hour, center position information indicating a center position of the facility (for example, latitude and latitude information), and the like. Here, the facility type indicates, for example, an industry of a facility such as a convenience store, a hospital, or a car dealer. The storage unit 32 may include, in addition to the map information, road information, map data for display for displaying backgrounds such as roads and road maps, positional information and type information of nodes (e.g., intersections, bending points, and end points of roads), positional information and type information of links that are routes connecting the nodes, and road network data including link cost data relating to cost information (e.g., distance, required time, etc.) of all the links, and the like.

The map information may be stored in the map information storage unit 321 in advance, or may be appropriately downloaded from a server device (not shown) or the like connected to the communication network 60 as necessary. Further, the map information may be appropriately modified according to user input or the like.

The positional information database 322 is a database constructed based on the positional information 121 and the mobile body ID 122 received from the onboard navigation device 10, and the positional information 221 and the mobile body ID 222 received from the mobile terminal 20. The positional information database 322 is constructed and updated by each functional block included in the control unit 31. Details of the positional information database 322 will be described later.

As will be described later, the parking position information table 323 is a table that stores positional information in which the parking position information recording unit 312 determined that the vehicle 50 is parked as a parking position of the vehicle in association with identification information of the vehicle 50. At this time, in addition to the parking position, the parking position information table 323 may store the parking period of time including the date and time information at the parking position.

In the following description, when the positional information 121 and the positional information 221 are described without being distinguished from each other, the reference numerals are omitted and are referred to as “positional information”. Similarly, when the mobile body ID 122 and the mobile body ID 222 are described without being distinguished from each other, the reference numerals are omitted and are referred to as a “mobile body ID”.

The communication unit 33 includes a DSP or the like, and realizes wireless communication and wired communication with other devices (e.g., the onboard navigation device 10 and the mobile terminal 20) via the communication network 60 in accordance with LTE (Long Term Evolution), 4G (4th Generation) and 5G (5th Generation) standards, and standards such as Wi-Fi (registered trademark). The communication unit 33 is used, for example, to receive positional information, user information, and a mobile body ID transmitted from each of the onboard navigation device 10 and the mobile terminal 20. However, the data transmitted and received between the communication unit 33 and another device is not particularly limited, and information other than the information may be transmitted and received.

Next, the control unit 31 will be described in detail. The control unit 31 includes a microprocessor including a CPU, RAM, ROM, and I/O. The CPU executes each program read from the ROM or the storage unit 32, reads information from the RAM, the ROM, and the storage unit 32, writes information to the RAM and the storage unit 32, and transmits and receives signals to and from the communication unit 33. Thus, the hardware and the software (program) cooperate to realize the processing in the present embodiment.

The control unit 31 includes, as functional blocks, a receiving unit 311, a parking position information recording unit 312, a parking lot determination unit 313, and a parking lot recording unit 314.

### <Receiving Unit 311>

The receiving unit 311 receives consecutive positional information from a plurality of vehicles 50 together with time information. More specifically, the reception unit 311 updates the positional information database 322 based on the consecutive positional information and the mobile body ID received from the mobile body via the communication unit 33.

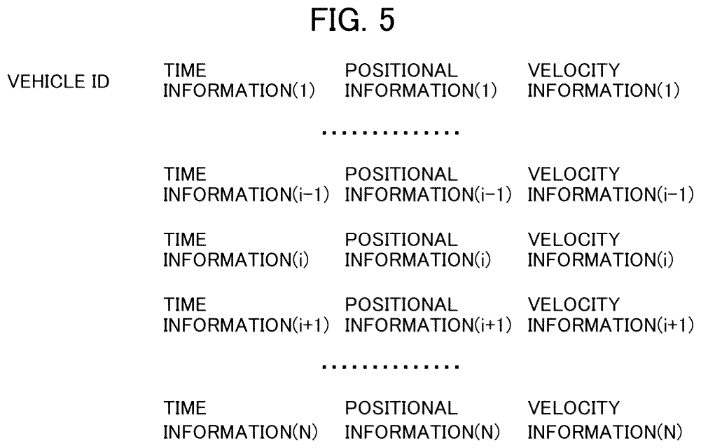

An example of the data structure of the positional information database 322 will be described with reference to FIG. 5. As shown in FIG. 5, the positional information database 322 may store “velocity information” for each vehicle 50 in addition to “mobile body ID”, “travel transition”, and “consecutive positional information and time information from the vehicle 50” received by the receiving unit 311.

As described above, the “mobile body ID” in the positional information database 322 is information for identifying the onboard navigation device 10 and the mobile terminal 20, which are transmission sources of the positional information and the like, and the vehicle 50 on which the onboard navigation device 10 and the mobile terminal 20 are mounted. The “travel transition” in the positional information database 322 is all consecutive positional information received from the mobile body from the start of transmission of the positional information, etc. until the present time. The parking position information including the parking position, the parking date and time, and the like can be specified by all the consecutive positional information. It is to be noted that the travel transition includes time information at which positioning of positional information was performed. Further, when the velocity information is transmitted from the mobile body together with the positional information, the received velocity information is stored in association with the time information and the positional information.

<Parking Position Information Recording unit 312>

The parking position information recording unit 312 determines that the vehicle 50 has been parked when there is no change in the vehicle position information for a predetermined period of time or more. Further, when the parking position information recording unit 312 determines that the vehicle 50 is parked, the parking position information recording unit 312 calculates a parking period of time of the vehicle 50. The parking position information recording unit 312 stores, as the parking position of the vehicle, the positional information in which it is determined that the vehicle 50 has been parked, in the parking position information table 323 in association with the identification information of the vehicle 50. Further, the parking position information recording unit 312 stores the parking period of time including the date and time information at the parking position in the parking position information table 323.

More specifically, for example, when the positional information is received last after the transmission of the positional information or the like is started once, and the positional information is not transmitted for a predetermined time, the parking position information recording unit 312 may determine that the position corresponding to the positional information received last is a parking position. In this case, the parking position information recording unit 312 may calculate, as the parking period of time of the vehicle 50, a predetermined time during which the positional information is not transmitted. Further, when the position corresponding to the positional information to be transmitted does not change for a certain period of time or more, this position may be determined as a parking position. In this case, the parking position information recording unit 312 may calculate the time during which the position does not change as the parking period of time of the vehicle 50. Further, when the interval of each time of a day at which the adjacent positional information is measured in the consecutive positional information received from the vehicle 50 is greater than or equal to a preset first time and less than or equal to a preset second time, and any of the velocity information of the adjacent positional information is less than or equal to a preset predetermined velocity V₀, the parking position information recording unit 312 may determine that the vehicle has stopped. In this case, the parking position information recording unit 312 may calculate the interval between the respective times in a day at which the adjacent positional information is measured as the parking period of time of the vehicle 50. Here, the predetermined velocity V₀ may be, for example, approximately a velocity at which the vehicle is stopped at a parking lot. Alternatively, the predetermined velocity V₀ may be 0 km/h. The predetermined velocity V₀ may be set according to the characteristics of each vehicle 50 (the characteristics of the driver during driving). As described above, for example, even in a case in which the device is a device which cannot transmit positional information when the ignition is on and/or when the ignition is off, it is still possible to identify information which can be expected to be stopped. When the vehicle 50 is configured to stop the transmission of the positional information of the vehicle 50 due to the ignition off, for example, as in the onboard navigation device 10 in a current engine vehicle, the current position transmitted immediately before the reception of the positional information of the vehicle 50 is stopped may be set as a parking position. In this case, the parking position information recording unit 312 may calculate, as the parking period of time of the vehicle 50, a time period from the stop of transmission of the positional information of the vehicle 50 to the next start of transmission of the positional information of the vehicle 50. Similarly, in a case where the transmission of positional information of the vehicle 50 is started due to ignition-on, for example, as in the onboard navigation device 10 in a current engine vehicle, the current position at which reception of the positional information of the vehicle 50 is started may be set as a parking position. In this case, the parking position information recording unit 312 may calculate the time difference from the time when the transmission of the positional information of the vehicle 50 is stopped before starting the reception of the positional information of the vehicle 50, as the parking period of time of the vehicle 50. When the stop signal information still can be transmitted even when the vehicle 50 stops, for example, as in an electric vehicle, the current position indicated by the stop signal or the most recent positional information of the positional information of the vehicle 50 may be used as a parking position. In this case, the parking position information recording unit 312 may calculate, as the parking period of time of the vehicle 50, a time period from reception of the stop signal information to the next reception of the activation signal information or the positional information. Similarly, when the vehicle 50 can transmit the activation signal information at the time of activation of the vehicle 50, for example, as in an electric vehicle, the current position indicated by the activation signal may be used as a parking position. In this case, the parking position information recording unit 312 may calculate, as the parking period of time of the vehicle 50, the time difference from the time when the stop signal information from the vehicle 50 before receiving the track signal information is received or the time when the last position signal is received.

### <Parking Lot Determination Unit 313>

The parking lot determination unit 313 determines the shape of the parking lot of one facility based on the center position information of the facility stored in the map information storage unit 321 and the plurality of pieces of parking position information stored in the parking position information table 323. Specifically, the parking lot determination unit 313 plots a plurality of pieces of parking position information stored in the parking position information table 323 into a plurality of grids within a predetermined range from the center position information of one facility stored in the map information storage unit 321, and determines that, when the number of pieces of parking position information plotted in the grid is equal to or greater than a predetermined value or exceeds a predetermined value, the grid corresponds to the shape information of the parking lot of the facility. The parking lot determination unit 313 may determine the outline of the group of grids determined as the parking lot of one facility as the shape information of the parking lot of the facility as boundary information of the parking lot of the facility. A detailed description will be given hereinafter with reference to the accompanying drawings.

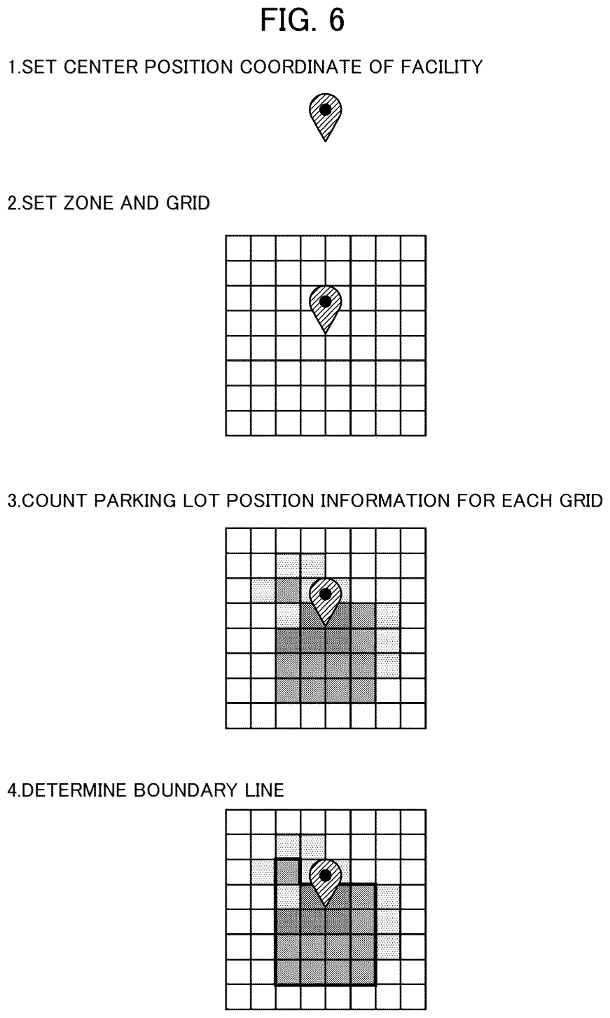

FIG. 6 is a schematic diagram showing a process in which the parking lot determination unit 313 determines a shape of a parking lot of one facility. A process of determining the shape of a parking lot of one facility will be described with reference to FIG. 6.

In FIG. 6, as a first process, first, the parking lot determination unit 313 sets the center position information of the facility as a target for determining the shape of the parking lot based on the map information stored in the map information storage unit 321.

Next, as a second process in FIG. 6, the parking lot determination unit 313 sets a zone having a predetermined range including the center position information of the facility, and divides the zone into a plurality of grids. Here, as shown in FIG. 6, the grids may be each a square grid (for example, a length of a side of about 2 m to 10 m) in the orthogonal coordinate system, or may be arranged in a radial manner in the polar coordinate system although not shown, but the shape of the grids is not limited thereto. Grids may be arranged in any shape. Further, each grid may be a minute grid such as 2 m×2 m.

Next, as a third process in FIG. 6, the parking lot determination unit 313 counts the number of pieces of parking position information included in each grid for each grid based on, for example, a plurality of pieces of parking position information within a predetermined period stored in the parking position information table 323. By doing so, as shown in FIG. 6, the number of vehicles parked in the grids within a predetermined period can be calculated for each grid included in the zone having a predetermined range.

Next, as a fourth process in FIG. 6, when the number of vehicles parked in each grid within a predetermined period is equal to or greater than a first threshold value set in advance, the parking lot determination unit 313 determines that the grid is an area included in the parking lot of the facility. By doing so, the parking lot determination unit 313 can determine the outline of the group of grids determined to be included in the parking lot of the facility as boundary information of the parking lot of the facility.

As described above, by using a small grid such as 2 m×2 m for each of the grids, it is possible to finely determine the boundary line information of the parking lot. Further, in the above-described process, the predetermined period of time is not limited to a period in which the date is designated (for example, one month of the designated date, a range of two designated dates, or the like), and may be, for example, a weekday or a holiday in the predetermined period. By doing so, for example, by comparing the shape of the parking lot of the facility in the weekday and the shape of the parking lot of the facility in the holiday, it is possible to estimate the temporary parking lot set in the holiday. As described above, the parking lot determination unit 313 can partition a zone having a predetermined range into a plurality of grids from the center position information of the facility without manually creating the shape of the parking lot of the facility, and determine whether each grid corresponds to a parking lot of the facility. By doing so, it is possible to create polygons of the parking lot of the facility without manual intervention.

In the case described with reference to FIG. 6, it has been described that the shape of the parking lot of one facility can be determined when a clear threshold value (first threshold value) exists between the grid included in the parking lot of one facility and the grid not included. On the other hand, for example, when the parking lots of two different facilities are located nearby (e.g., adjacent along a street), it is necessary to determine the boundary between the parking lots of the two different facilities. Therefore, the parking lot determination unit 313 may regard a grid whose number of pieces of parking position information of a grid determined to be a parking lot of one facility changes from a decrease to an increase as a parking lot of another facility different from the facility, and determine the shape information of the parking lot of the facility as the boundary information of the parking lots between the facility and the different facility. Specifically, for example, a portion where the attenuation rate of the number of pieces of the parking position information in the grid changes (also referred to as a “change portion of the attenuation rate”) may be determined as a boundary between both parking lots. A detailed description will now be provided with reference to the accompanying drawings.

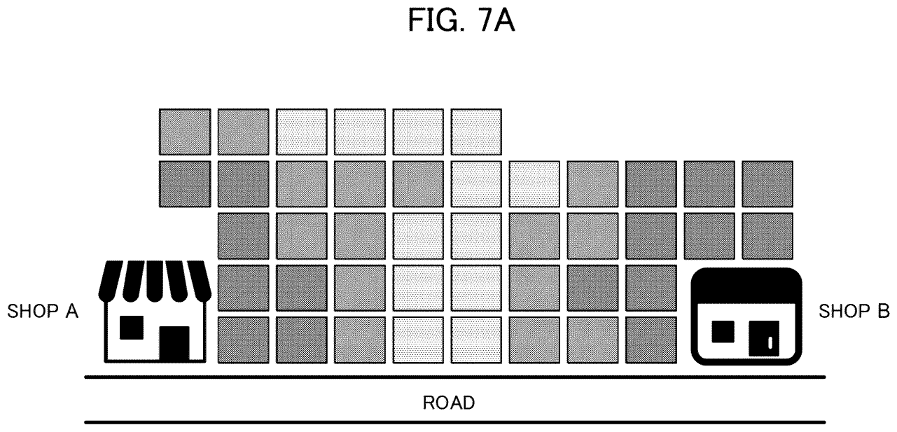

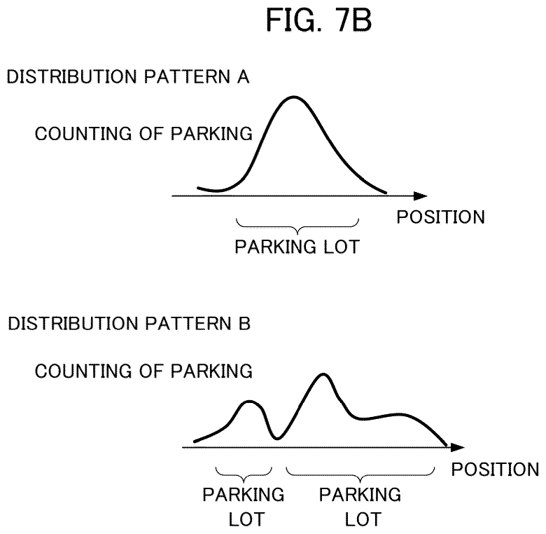

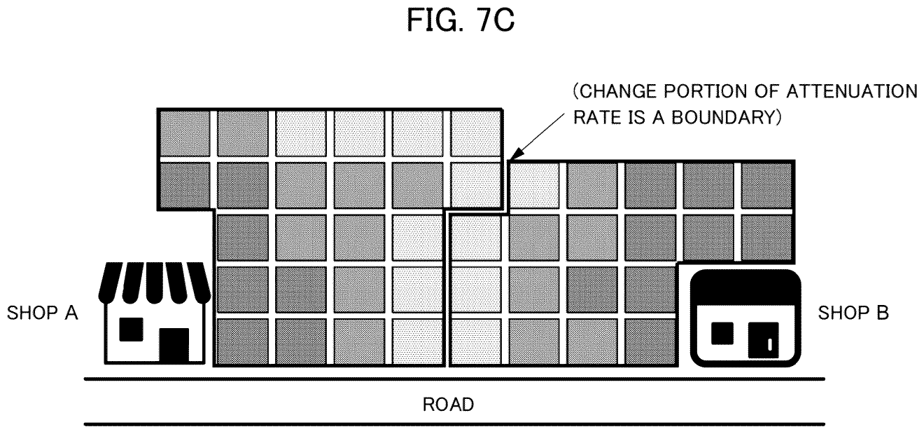

FIGS. 7A to 7C are diagrams, each showing an outline when the parking lot determination unit 313 determines the boundary between the parking lots of the two facilities, for example, when the parking lots of the two different facilities are located nearby (e.g., adjacent to each other along a street). With reference to FIGS. 7A to 7C, the process of determining the boundary of the parking lots of two facilities will be described.

As shown in FIG. 7A, when one facility (e.g., store A) and another facility (e.g., store B) are positioned so as to be adjacent to each other along a street, for example, as described above, the parking lot determination unit 313 sets a zone having a predetermined range including the center position information of store A and the center position information of store B, and divides the zone into a plurality of grids. As described above, the parking lot determination unit 313 counts the number of pieces of parking position information included in each grid for each grid based on, for example, a plurality of pieces of parking position information in a predetermined period stored in the parking position information table 323. By doing so, the number of vehicles parked in the grid within the predetermined period is calculated for each grid included in the zone having the predetermined range. In this case, if the number of pieces of the parking position information included in each grid is equal to or greater than the first threshold value, the boundary between the parking lots of the two facilities cannot be determined in the above-described process.

In such a case, the parking lot determination unit 313 may identify, for example, a grid in which the number of pieces of parking position information in the grid determined to be a parking lot of the store A changes from decreasing to increasing. FIG. 7B is a diagram showing an outline of distribution of the number of pieces of parking position information in a plurality of grids. As described above, a distribution pattern A shown in FIG. 7B indicates a pattern in which the number of vehicles parked in a plurality of grids adjacent to each other within a predetermined period can be discriminated between the case where the number of vehicles parked in a plurality of grids is equal to or greater than the first threshold value and the case where the number of vehicles parked in a plurality of grids is equal to or less than the first threshold value. On the other hand, a distribution pattern B shown in FIG. 7B is a diagram schematically showing the distribution of the number of pieces of parking position information in a plurality of adjacent grids when two facilities are located, for example, near each other. As shown in FIG. 7B, for example, if there is a boundary between two parking lots, the boundary can be regarded as a boundary of grids in which the number of pieces of parking position information in the grid is minimized. Then, the parking lot determination unit 313 may regard a grid whose number of pieces of parking position information of a grid determined to be a parking lot of one facility changes from a decrease to an increase as a parking lot of another facility different from the facility, and determine the shape information of the parking lot of the facility as boundary information of the parking lot between the facility and the different facility. Specifically, as shown in FIG. 7C, the parking lot determination unit 313 refers to the grid sequentially from the store A side, and can identify a grid in which the number of pieces of parking position information in the grid changes from decreasing to increasing. Similarly, the parking lot determination unit 313 refers to the grid sequentially from the store B side, and can identify a grid in which the number of pieces of parking position information in the grid changes from decreasing to increasing. In this way, the parking lot determination unit 313 may determine a portion where the attenuation rate of the number of pieces of parking position information in the grid changes (“change portion of the attenuation rate”) as a boundary between the two parking lots. As described above, even when two facilities are located nearby, for example, the parking lot determination unit 313 can determine the boundary without manually creating the shape of each parking lot. It is to be noted that the parking lot determination unit 313 may be able to determine the boundary depending on the facility type even when two facilities are located, for example, near each other (for example, when the two facilities are adjacent to each other along a street).

Specifically, for example, in a case where the facility type is a convenience store, the indicator of the parking period of time of the vehicle in the convenience store is, for example, about 10 minutes, and in a case where the facility type is a hospital, the indicator of the parking period of time of the vehicle in the hospital is, for example, about one hour. In such a way, the indicator of the parking period of time of the vehicle is associated with each facility type in advance. These periods of times are merely examples and are not limited to these values. As an indicator of the parking period of time, a predetermined time range may be set. By doing so, for example, when the convenience store and the hospital are located near each other (for example, when the convenience store and the hospital are adjacent to each other along the street), and when the number of pieces of the parking position information is counted by setting the predetermined period of time for determining that the vehicle 50 is parked by the parking position information recording unit 312 to be, for example, about one hour, it is assumed that the number of pieces of the parking position information in the grid included in the parking lot of the convenience store is clearly smaller than the number of pieces of the parking position information in the grid included in the parking lot of the hospital. Then, the parking lot determination unit 313 can determine the boundary between the parking lot of the hospital and the parking lot of the convenience store.

### <Parking Lot Recording Unit 314>

The parking lot recording unit 314 stores the shape information of the parking lot of the facility determined by the parking lot determination unit 313 in the map information storage unit 321. Specifically, the parking lot recording unit 314 stores the center position information of the facility and the shape information of the facility in the map information storage unit 321. This makes it possible to create a map having the shape of the parking lot without manually creating the shape of the parking lot of the facility. The configuration of each functional unit of the parking lot information analysis device 30 exemplified as the present embodiment has been described above.

### Operation of Present Embodiment

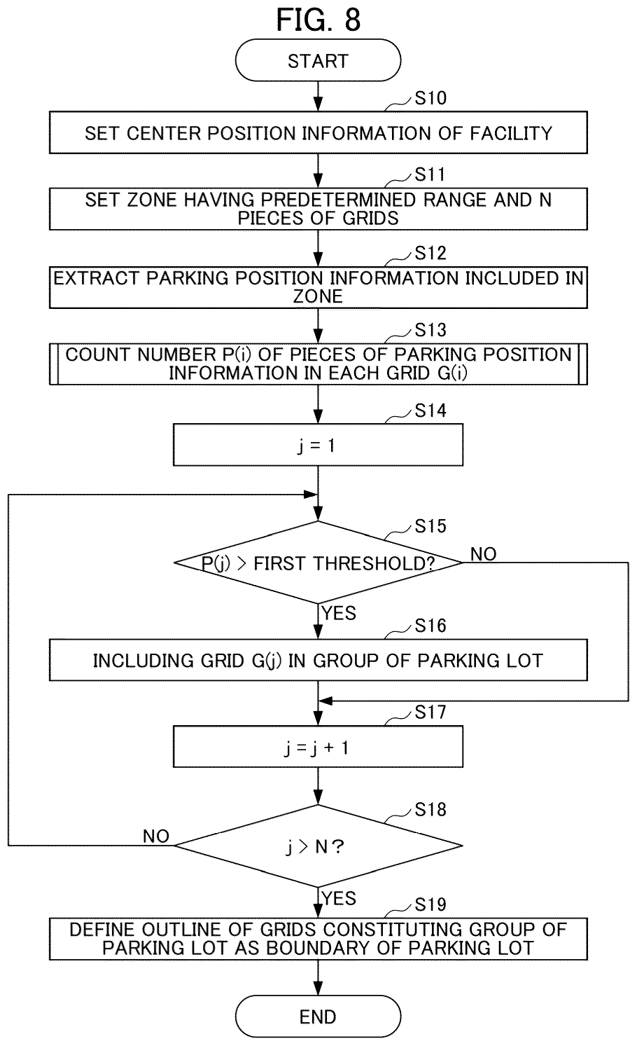

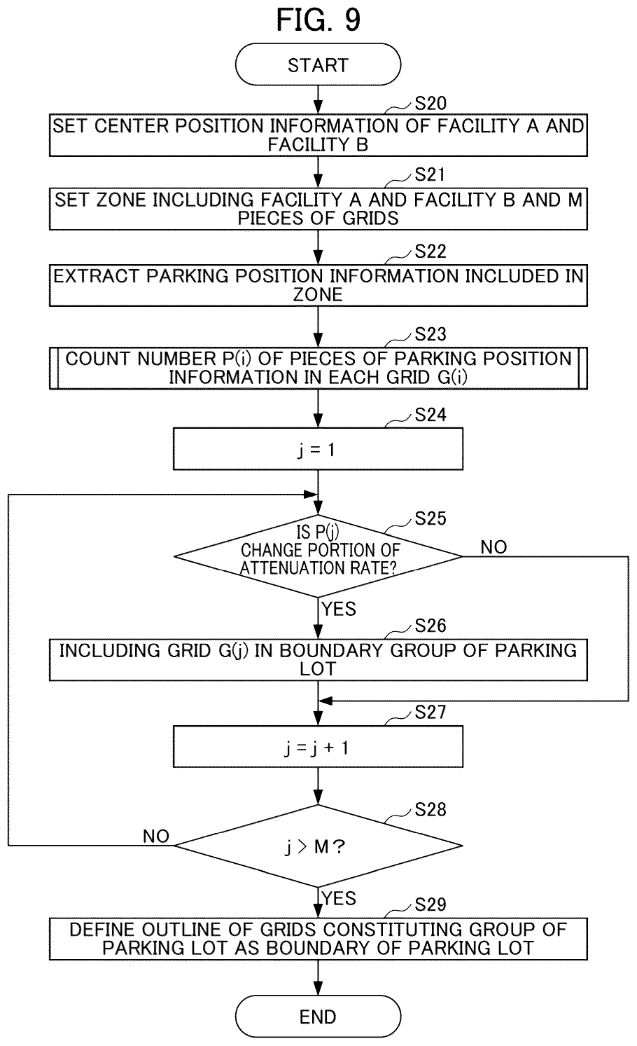

Next, the operation of the present embodiment will be described with reference to flowcharts shown in FIGS. 8 and 9. FIG. 8 is a flowchart showing the operation of determining the shape of the parking lot of one facility. FIG. 9 is a flowchart showing an operation of determining a boundary between two facility parking lots located nearby (e.g., adjacent along a street). It should be noted that the operation process in which the parking lot information analysis device 30 (the receiving unit 311) receives identification information, positional information, time information, and the like of the vehicle 50 from each vehicle 50 to create and update the positional information database 322, and the operation process in which the parking lot information analysis device 30 (the parking position information recording unit 312) determines the parking position of each vehicle 50 from the shift of the positional information of each vehicle 50 and determines the determination position information, the time when the vehicle is parked, and the like to create and update the parking position information table 323 are well known to those skilled in the art, and detailed descriptions thereof are omitted.

Referring to FIG. 8, in Step S10, the parking lot information analysis device 30 (the parking lot determination unit 313) selects one facility and sets the center position information of the facility based on the map information stored in the map information storage unit 321.

In Step S11, the parking lot information analysis device 30 (the parking lot determination unit 313) sets a zone having a predetermined range including the center position information of the facility, and divides the zone into a plurality of grids (i) (1≤i≤N). Here, the number of grids is N, and each of the N grids is identified by index i (1≤i≤N) and defined as G (i).

In Step S12, the parking lot information analysis device 30 (the parking lot determination unit 313) extracts all of the parking lot position information (referred to as “in-zone parking lot position information”) included in the zone set in Step S11 among the plurality of pieces of parking lot position information within a predetermined period stored in the parking position information table 323.

In Step S13, the parking lot information analysis device 30 (the parking lot determination unit 313) counts the number (i) of pieces of the parking position information included in each grid G(i), for example, by using a counter (i), based on the in-zone parking position information group extracted in Step S12. The number of pieces of the parking position information included in the grid G(i) is P(i) (1≤i≤N).

In Step S14, the parking lot information analysis device 30 (the parking lot determination unit 313) initializes j.

In Step S15, the parking lot information analysis unit 30 (the parking lot determination unit 313) calculates the number P (j) pieces of the parking lot position information included in the grid G (j). If the number P (j) satisfies P (j)>(or ≥) first threshold, the processing advances to Step S16, and if the number P (j) does not satisfies P (j)>(or ≥) first threshold, the processing advances to Step S17.

In Step S16, the parking lot information analysis device 30 (the parking lot determination unit 313) determines the grid G(j) as a grid included in the parking lot of the facility, and includes the grid G(j) in a group constituting the parking lot of the facility.

In Step S17, the parking lot information analysis device 30 (the parking lot determination unit 313) adds 1 to j.

In Step S18, the parking lot information analysis device 30 (the parking lot determination unit 313) determines whether or not j>N. If j>N, the processing advances to Step S19. If j≤N, the processing advances to Step S15.

In Step S19, the parking lot information analysis device 30 (the parking lot determination unit 313) determines the shape information of the parking lot of the facility by using the group of grids constituting the parking lot of the facility as the shape information of the parking lot of the facility and using the outline of the group of grids as the boundary information of the parking lot of the facility. Then, the parking lot information analysis device 30 (the parking lot recording unit 314) stores the shape information of the parking lot of the facility in the map information storage unit 321. The operation of the parking lot information analysis device 30 to determine the shape of the parking lot of the facility based on the center position information of one facility stored in the map information storage unit 321 and the plurality of pieces of parking position information stored in the parking position information table 323 has been described above. The parking lot information analysis device 30 can determine the shape of the parking lot of all the facilities by performing the above-described operation for all the facilities included in the map information.

Next, with reference to the flowchart shown in FIG. 9, the operation of the present embodiment, specifically, the operation in which the parking lot information analysis device 30 determines the boundary between two facility parking lots located nearby (e.g., adjacent along a street road), will be described.

Referring to FIG. 9, in Step S20, the parking lot information analysis device 30 (the parking lot determination unit 313) sets the center position information of a facility (referred to as “facility A”) and the center position information of another facility (referred to as “facility B”) located nearby (e.g., adjacent along a street).

In Step S21, the parking lot information analysis device 30 (the parking lot determination unit 313) sets a zone having a predetermined range including the center position information of the facility A and the center position information of the facility B, and divides the zone into a plurality of grids. Here, the number of grids is defined as M, and each of the M grids is identified by index i (1≤i≤M) and defined as G(i).

In Step S22, the parking lot information analysis device 30 (the parking lot determination unit 313) extracts all of the parking position information (referred to as “in-zone parking position information”) included in the zone set in Step S21 among the plurality of pieces of parking position information within a predetermined period stored in the parking position information table 323.

In Step S23, the parking lot information analysis device 30 (the parking lot determination unit 313) counts the number (i) of pieces the parking position information included in each grid G(i), for example, by using a counter (i), based on the in-zone parking position information group extracted in Step S22. The number of the parking position information included in the grid G(i) is P(i) (1≤i≤M).

In Step S24, the parking lot information analysis device 30 (the parking lot determination unit 313) initializes j.

In Step S25, the parking lot information analysis device 30 (the parking lot determination unit 313) compares and determines whether or not the number P(j) of pieces of the parking position information included in the grid G(j) is smaller than the number P of pieces of the parking position information included in the grids adjacent to the grid G(j). When it is smaller (the case of “change portion of the attenuation rate”), the processing advances to Step S26. If it is not smaller, the processing advances to Step S27.

In Step S26, the parking lot information analysis device 30 (the parking lot determination unit 313) determines that the grid G (j) is located at the boundary between the parking lot of the facility A and the parking lot of the facility B, and includes the grid G(j) in a group of grids constituting the boundary between the parking lot of the facility A and the parking lot of the facility B.

In Step S27, the parking lot information analysis device 30 (the parking lot determination unit 313) adds 1 to j.

In Step S28, the parking lot information analysis device 30 (the parking lot determination unit 313) determines whether or not j>M. If j>M, the processing advances to Step S29. If j≤M, the processing advances to Step S25.

In Step S29, the parking lot information analysis device 30 (the parking lot determination unit 313) determines a group of grids constituting a boundary between the parking lot of the facility A and the parking lot of the facility B as the boundary information between the parking lot of the facility A and the parking lot of the facility B. Then, the parking lot information analysis device 30 (the parking lot recording unit 314) stores the boundary information between the parking lot of the facility A and the parking lot of the facility B in the map information storage unit 321. As described above, the operation whereby the parking lot information analysis device 30 determines the boundary without manually creating the shapes of the respective parking lots when two facilities are located, for example, near each other has been described. As described above, even when two facilities are located, for example, near each other, the parking lot determination unit 313 can determine the boundary without manually creating the shape of each parking lot. The parking lot information analysis device 30 can determine the boundary between the parking lots of all adjacent facilities by performing the above-described operation for all two adjacent facilities included in the map information.

According to the present embodiment described above, it is possible to provide the parking lot information analysis device and the parking lot information analysis method for determining the shape of a parking lot of a facility by calculating the estimated number of parked vehicles in each grid in a plurality of grids in a predetermined range from the center point of the facility, and by determining whether each grid corresponds to a parking lot of the facility without manually creating the shape of the parking lot of the facility.

### <Hardware and Software>

Each of the devices included in the navigation system can be implemented by hardware, software, or a combination thereof. Further, a navigation method performed by cooperation of each device included in the navigation system can also be implemented by hardware, software, or a combination thereof. Here, “implemented by software” indicates that it is realized by a computer reading and executing a program.

The program may be stored and provided to a computer using various types of non-transitory computer-readable media (non-transitory computer readable medium). Non-transitory computer-readable media includes various types of tangible storage media. Examples of non-transitory computer-readable media include magnetic recording media (for example, flexible disks, magnetic tapes, hard disk drives, etc.), magneto-optical recording media (e.g., magneto-optical disks), CD-ROM (Read Only Memory), CD-R, CD-R/W, and semiconductor memory (for example, mask ROM, PROM (Programmable ROM), EPROM (Erasable PROM), flash ROM, and RAM (random access memory)). The program may also be provided to a computer by various types of transitory computer readable media (transitory computer readable medium). Examples of transitory computer-readable media include electrical signals, optical signals, and electromagnetic waves. The transitory computer-readable medium can provide the program to the computer via wired or wireless communication paths such as electric wires and optical fibers.

Although the above-described embodiments are preferred embodiments of the present invention, the scope of the present invention is not limited to the above-described embodiments, and various modifications can be made without departing from the gist of the present invention.

### Modified Example 1

Some facilities may set a temporary parking lot for a holiday. When a temporary parking lot is set, as described above, for example, the parking lot determination unit 313 distinguishes the predetermined period 1 composed of weekdays and the predetermined period 2 composed of holidays, and counts the number of pieces of parking position information included in each grid for each grid in the predetermined period 1 and the predetermined period 2, based on the plurality of pieces of parking position information stored in the parking position information table 323, so that the shape 1 of the parking lot of the facility in the weekday and the shape 2 of the parking lot of the facility in the weekday can be determined. By doing so, if there is a grid included in the shape 2 and not included in the shape 1, it is possible to determine the grid as the shape information of the temporary parking lot set to the holiday.

### Modified Example 2

For example, the functional configurations of FIG. 2, FIG. 3, and FIG. 4 are merely illustrative and do not limit the functional configuration of the present embodiment. That is, it is sufficient as long as each device is provided with a function capable of executing a series of processes relating to the vehicle position analysis function of the present invention as a whole, and what kind of functional block is used to realize this function is not particularly limited to the examples of FIGS. 2, 3, and 4. In addition, the above-described embodiment may be modified as, for example, a modified example described below. The modified examples described below may be further combined.

### Modified Example 3

In the above-described embodiment, the parking lot information analysis device 30 is implemented by a single server device, but the functions of the parking lot information analysis device 30 may be distributed to a plurality of server devices as appropriate. Further, each function of the parking lot information analysis device 30 may be implemented using a virtual server function or the like on the cloud.

### Modified Example 4

In the above-described embodiment, the parking lot information analysis device 30 receives identification information, positional information, time information, and the like of the vehicle 50 from each vehicle 50 via the communication unit 33. Further, the receiving unit 311 is configured to appropriately create and update the positional information database 322 based on the identification information, the positional information, the time information, and the like received from each vehicle 50. Alternatively, an FCD (Floating Car Data) server (provisional name) may be provided separately from the parking lot information analysis device 30, and the FCD server may receive identification information, positional information, time information, and the like of the vehicle 50 from each vehicle 50. In this case, the parking lot information analysis device 30 may acquire the positional information of each vehicle from the FCD server and create and update the positional information database 322 (travel transition) as appropriate.

### EXPLANATION OF REFERENCE NUMERALS

1 parking lot information analysis system
10 onboard navigation device
11 control unit
111 route guide unit
112 positional information transmission unit
12 storage unit
13 communication unit
14 sensor unit
20 mobile terminal
21 control unit
111 route guide unit
112 positional information transmission unit
22 storage unit
23 communication unit
24 sensor unit
30 parking lot information analysis device
31 control unit
311 receiving unit
312 parking lot position recording unit
313 parking lot determination unit
314 parking lot recording unit
32 storage unit
321 map information storage unit
322 positional information database
323 parking position information table
33 communication unit
50, 50a, 50b vehicle
60 communication network

1. A parking lot information analysis device comprising:
a map information storage unit that stores map information including center position information of a plurality of facilities;
a receiving unit that receives consecutive positional information, together with time information, from each of a plurality of vehicles;
a parking lot position information recording unit that determines that, when there is no change in the positional information for a predetermined period of time or more, a vehicle of the positional information has been parked, and stores the positional information as parking position information of the vehicle; and
a parking lot determination unit that plots a plurality of pieces of the parking position information into a plurality of grids within a predetermined range from center position information of one facility stored in the map information storage unit, and determines that, when a number of pieces of parking position information plotted in the grid is equal to or greater than a predetermined value, the grid corresponds to shape information of a parking lot of the facility.

2. The parking lot information analysis device according to claim 1, wherein the parking lot determination unit determines an outline of a group of grids determined as the parking lot as the shape information of the parking lot of the facility as boundary information of the parking lot.

3. The parking lot information analysis device according to claim 1, wherein the parking lot determination unit regards a grid having a number of pieces of parking position information of the grid determined to be the parking lot changes from a decrease to an increase as a parking lot of one other facility different from the facility, and determines the shape information of the parking lot of the facility as boundary information of parking lots of the facility and the other facility.

4. The parking lot information analysis device according to claim 1, further comprising a parking lot recording unit that stores the shape information of the parking lot of the facility determined by the parking lot determination unit in the map information storage unit.

5. A parking lot information analysis method executed by a computer, the method comprising the steps of:
storing map information including center position information of a plurality of facilities;
receiving consecutive positional information, together with time information, from each of a plurality of vehicles;
determining that, when there is no change in the positional information for a predetermined period of time or more, a vehicle of the positional information has been parked, and storing the positional information as parking position information of the vehicle; and
plotting a plurality of pieces of the parking position information into a plurality of grids within a predetermined range from center position information of one facility stored in the map information storage unit, and determining that, when a number of pieces of parking position information plotted in the grid is equal to or greater than a predetermined value, the grid corresponds to shape information of a parking lot of the facility.
